(19) United States
(12) Patent Application Publication
(10) Pub. No.: US 2026/0280205 A1
(43) Pub. Date: Sep. 17, 2026

(54) HYBRID CONNECTOR AND A HYBRID CABLE UNIT TO PROVIDE A FIBER-OPTIC CONNECTION AND A POWER CONNECTION FOR DEVICES FOR SEATS IN A TRANSPORTATION VEHICLE

(71) Applicant: Panasonic Avionics Corporation, Irvine, CA (US)

(72) Inventors: Thomas L. Peterson, Huntington Beach, CA (US); Mark Bennett, Corona, CA (US); Robert Connor Gleason, Foothill Ranch, CA (US)

(21) Appl. No.: 19/077,438

(22) Filed: Mar. 12, 2025

(51) Int. Cl. H01R 24/86; B60R 16/023; B60R 16/03; G02B 6/38; H01R 107/00

(52) U.S. Cl. CPC H01R 24/86; B60R 16/023; B60R 16/03; G02B 6/3883; H01R 2107/00; H01R 2201/26

(57) ABSTRACT

A hybrid connector for a seat box of a transportation vehicle and a cable using the hybrid connector are provided. The hybrid connector includes a power interface component including power connections configured to deliver three-phase electric power with three alternating current phases for the seat box, the power interface component configured to provide a power interface via the power connections to receive or send the three-phase electric power, and further includes a fiber optic interface component comprising fiber optic connections configured for data communication via optical fibers, the fiber optic interface component configured to provide a fiber optic interface via the fiber optic connections to receive or send data. The hybrid connector further includes a housing configured to house the power interface component and the fiber optic interface component and including a single hybrid interface providing the power interface and the fiber optic interface.

### TECHNICAL FIELD

The present disclosure relates to a connector for a seat box in a transportation vehicle in general, and more particularly, to a hybrid connector and its uses to provide a multi-fiber fiber optic communication and a three-phase power connection for a seat-related device, such as a seat box, in a transportation vehicle.

### BACKGROUND

Transportation vehicles, for example, aircraft, trains, buses, recreation vehicle, boats and other similar vehicles use various computing devices for providing various functions, including entertainment, system control, content storage, and other functions. These computing devices include hardware (for example, servers, switches, network interface cards, storage adapters, storage devices and others) and software (for example, server applications, operating systems, firmware, management applications, application programming interface (APIs) and others).

For example, aircrafts today have individualized functional equipment dedicated to a passenger seat, which can be utilized by a passenger, such as adjustable seats, adjustable environmental controls, adjustable lighting, telephony systems, video and/or audio entertainment systems, crew communication systems, and the like. For example, many commercial airplanes have individualized video and audio entertainment systems, often referred to as “in-flight entertainment” or “IFE” systems.

An IFE system may involve a seat box that has a data connection to a server as well as a power supply connection to a power generator to supply power to the seat box. Providing such connections may involve connection interfaces and cables that connect to the connection interfaces. Continuous efforts are being made to develop technologies to provide an efficient approach to provide the data connection and the power supply connection to seat boxes of a transportation vehicle.

### BRIEF DESCRIPTION OF THE DRAWINGS

The various features of the present disclosure will now be described with reference to the drawings of the various aspects disclosed herein. In the drawings, the same components may have the same reference numerals. The illustrated aspects are intended to illustrate, but not to limit the present disclosure. The drawings include the following Figures:

FIG. 1A shows an example of an operating environment for implementing the various aspects of the present disclosure on an aircraft;

FIG. 1B shows an example of the operating environment on a non-aircraft transportation vehicle type, according to one aspect of the present disclosure;

FIG. 2 shows an example of a content distribution system, used according to one aspect of the present disclosure;

FIG. 3A shows an example of an overall system of an in-flight entertainment and communication system on an aircraft, according to one aspect of the present disclosure;

FIG. 3B shows an example of seat boxes receiving data and electric power, according to one aspect;

FIG. 4A shows a front view of a hybrid connector having an ethernet interface and a power interface, according to some aspects;

FIG. 4B is an example diagram showing a seat box with at least one hybrid connector having an ethernet interface and a power interface, according to some aspects;

FIG. 4C is an example diagram showing connectors having multi-fiber fiber optic interfaces, according to some aspects;

FIG. 4D is an example diagram showing connectors having power connections for supplying electric power, according to some aspects;

FIG. 5A shows an example showing a combination of a multi-fiber fiber optic interface and a power interface to form a hybrid connector for a seat box of a transportation vehicle to provide a hybrid interface with a power interface and a multi-fiber fiber optic interface, according to an aspect of the present disclosure;

FIG. 5B shows an enlarged front view of the hybrid connector of FIG. 5A, according to an aspect of the present disclosure;

FIG. 5C shows a side view of the hybrid connector of FIG. 5A and FIG. 5B, according to an aspect of the present disclosure;

FIG. 5D shows an example male hybrid connector and an example female hybrid connector for a seat box of a transportation vehicle, according to an aspect of the present disclosure;

FIG. 5E shows an example hybrid connecter set including a first hybrid connector and a second hybrid connector, implemented in a seat device of a transportation vehicle, according to an aspect of the present disclosure;

FIG. 5F shows an example hybrid cable unit for providing power and data to a seat box or another device in a transportation vehicle, where the hybrid cable unit includes a first hybrid connector at one end of a hybrid cable and a second hybrid connector at the other end of the hybrid cable, according to an aspect of the present disclosure;

FIG. 5G shows an example diagram illustrating a seat box connecting to a hybrid cable unit via a hybrid connector set in a transportation vehicle, according to an aspect of the present disclosure;

FIG. 5H shows an example diagram illustrating multiple seat boxes connected to one another via hybrid cable units and via hybrid connector sets in a transportation vehicle, according to an aspect of the present disclosure.

### DETAILED DESCRIPTION

In one aspect, innovative technology is disclosed for a hybrid connector for a seat box or another device in a transportation vehicle to provide a power interface to deliver three-phase electric power and a multi-fiber fiber optic interface to communicate data. In another aspect, innovative technology is disclosed for a hybrid connector set utilizing two hybrid connectors and for a hybrid cable set utilizing a hybrid cable and two hybrid connectors. As described below in detail, the innovative technology provides a hybrid connector having a hybrid interface that includes both the power interface to deliver three-phase electric power with three alternating current phases and the multi-fiber fiber optic interface to communicate data via multiple optical fibers. Details regarding the innovative techniques are provided below.

As a preliminary note, the terms “component”, “module”, “system”, and the like as used herein are intended to refer to a computer-related entity, either software-executing general-purpose processor, hardware, firmware or a combination thereof. For example, a component may be, but is not limited to being, a process running on a hardware processor, a hardware processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer/machine readable media including, but not limited to, an ASIC (application specific integrated circuit), CD (compact disc), DVD (digital video disk), ROM (read only memory), hard disk, EEPROM (electrically erasable programmable read only memory), solid state memory device or any other storage device, in accordance with the claimed subject matter.

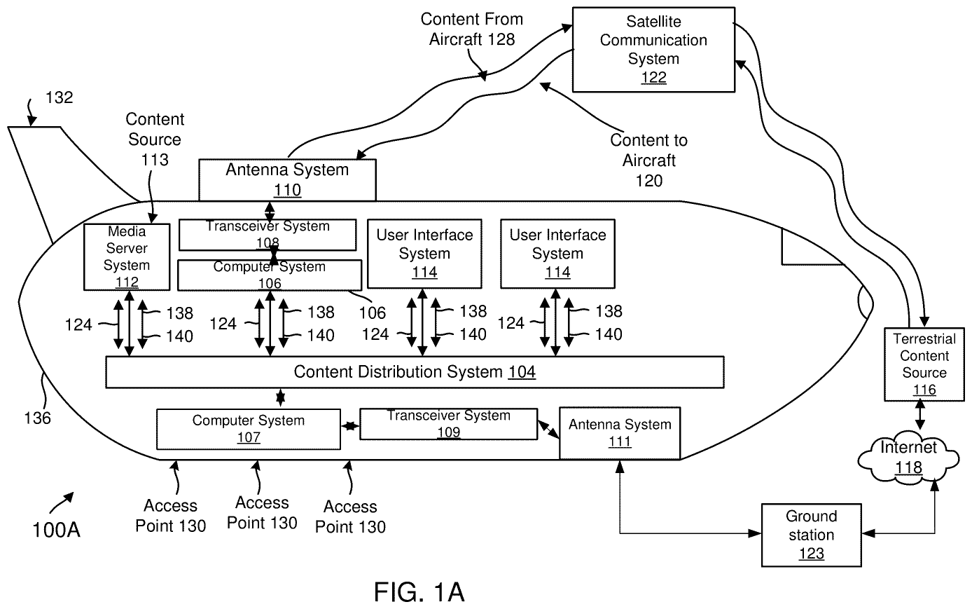

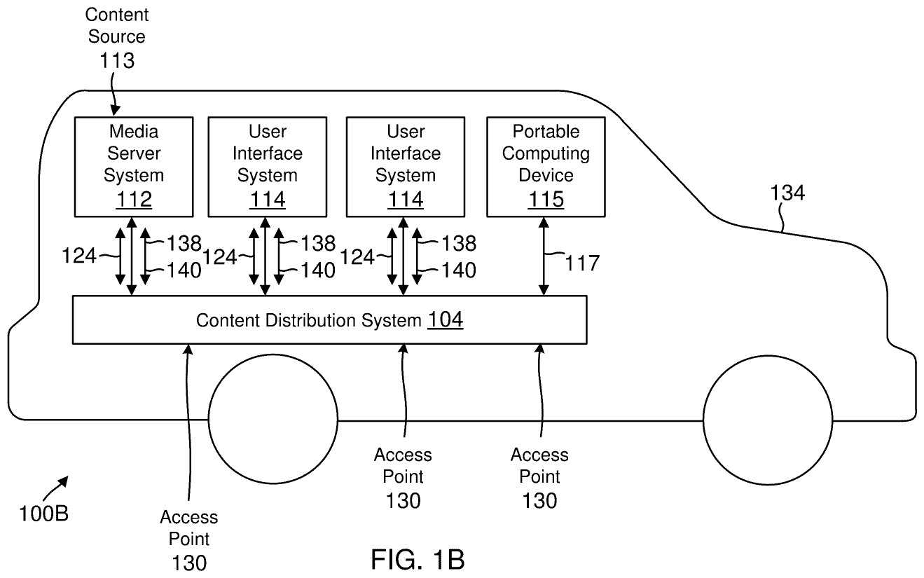

Vehicle Information System: FIG. 1A shows an example of a generic vehicle information system 100A (also referred to as system 100A) that can be configured for installation aboard an aircraft 132, according to one aspect of the present disclosure. When installed on an aircraft, system 100A can comprise an aircraft passenger IFE system, such as the Series 2000, 3000, eFX, eX2, eXW, eX3, NEXT, and/or any other in-flight entertainment system developed and provided by Panasonic Avionics Corporation (without derogation of any trademark rights of Panasonic Avionics Corporation) of Lake Forest, California, the assignee of this application.

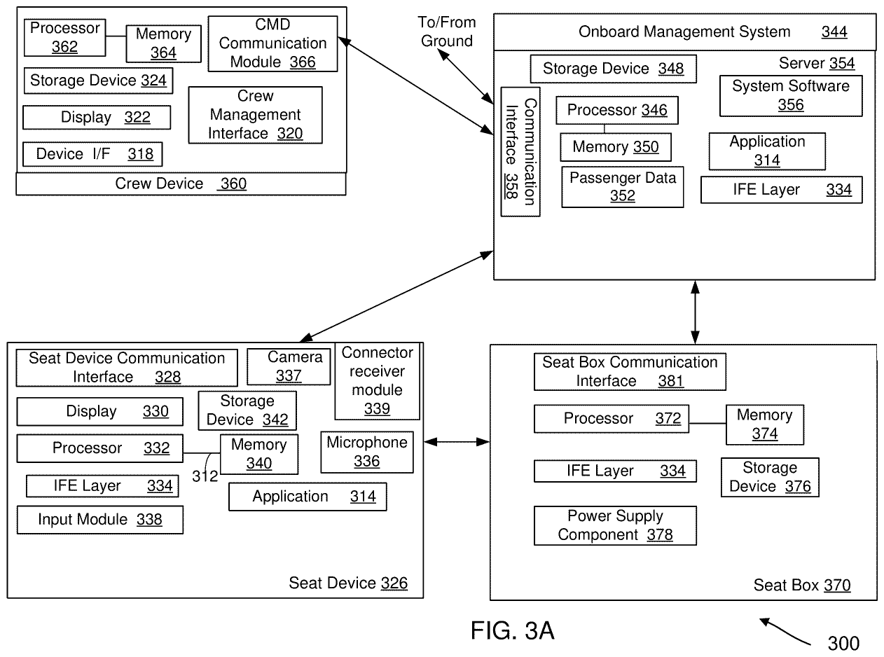

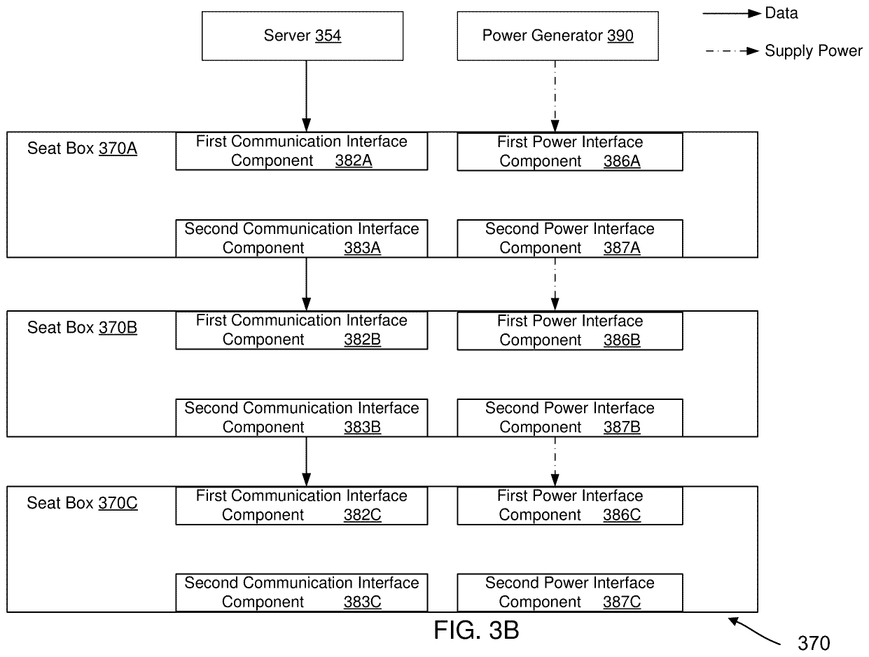

System 100A may include one or more content source 113 and one or more user (or passenger) interface systems (may also be referred to as a seat device/seatback device/IFE device 326 described below with respect to FIG. 3) 114 that communicate with a real-time content distribution system 104.

As an example, the content sources 113 may include one or more internal content sources, such as a media server system 112, that are installed aboard the aircraft 132, one or more remote (or terrestrial) content sources 116 that can be external from the aircraft 132, or a distributed content system. The media server system 112 can be provided as an information system controller for providing overall system control functions for system 100A and/or for storing viewing content 124, including pre-programmed viewing content and/or content 120 downloaded to the aircraft, as desired. The viewing content 124 can include television programming content, music content, podcast content, photograph album content, audiobook content, and/or movie content without limitation. The viewing content as shown and described herein is not exhaustive and are provided herein for purposes of illustration only and not for purposes of limitation.

The server system 112 can include, and/or communicate with, one or more conventional peripheral media storage systems (not shown), including optical media devices, such as a digital video disk (DVD) system or a compact disk (CD) system, and/or magnetic media systems, such as a solid state drive (SSD) system, or a hard disk drive (HDD) system, of any suitable kind, for storing preprogrammed content and/or downloaded content 120.

The viewing content 124 can comprise any conventional type of audio and/or video viewing content, such as stored (or time-delayed) viewing content and/or live (or real-time) viewing content. As desired, the viewing content 124 can include geographical information. Alternatively, and/or additionally, to entertainment content, such as live satellite television programming and/or live satellite radio programming and/or live wireless video/audio streaming, the viewing content likewise can include two-way communications, such as real-time access to the Internet 118 and/or telecommunications and/or a ground station 123 that communicates through an antenna 111 to a transceiver system 109, and a computer system 107 (similar to computer system 106). The functionality of computer system 107 is like computing system 106 for distributing content using the content distribution system 104 described herein. It is noteworthy that although two antenna systems 110/111 have been shown in FIG. 1A, the adaptive aspects disclosed herein may be implemented by fewer or more antenna systems.

Being configured to distribute and/or present the viewing content 124 provided by one or more selected content sources 113, system 100A can communicate with the content sources 113 in real time and in any conventional manner, including via wired and/or wireless communications. System 100A and the terrestrial content source 116, for example, can communicate directly and/or indirectly via an intermediate communication system, such as a satellite communication system 122 or the ground station 123.

System 100A can receive content 120 from a selected terrestrial content source 116 and/or transmit (upload) content 128, including navigation and other control instructions, to the terrestrial content source 116. In one aspect, content 120 includes media content that is stored persistently on the aircraft for passenger consumption. The media content for persistence storage is handled differently than live television content, as described below. As desired, terrestrial content source 116 can be configured to communicate with other terrestrial content sources (not shown). Terrestrial content source 116 is shown as providing access to the Internet 118. Although shown and described as comprising the satellite communication system 122 and the cellular base station 123 for purposes of illustration, the communication system can comprise any conventional type of wireless communication system, such as any wireless communication system and/or an Aircraft Ground Information System (AGIS) communication system.

To facilitate communications with the terrestrial content sources 116, system 100A may also include an antenna system 110 and a transceiver system 108 for receiving the viewing content from the remote (or terrestrial) content sources 116. The antenna system 110 preferably is disposed outside, such as an exterior surface of a fuselage 136 of the aircraft 132. The antenna system 110 can receive viewing content 124 from the terrestrial content source 116 and provide the received viewing content 124, as processed by the transceiver system (may also referred to as broadband controller) 108, to a computer system 106 of system 100A. The computer system 106 can provide the received viewing content 124 to the media (or content) server system 112 and/or directly to one or more of the user interfaces 114 including a PED, as desired. Although shown and described as being separate systems for purposes of illustration, the computer system 106 and the media server system 112 can be at least partially integrated.

The user interface system 114 may be computing terminals in communication with an access point 130. The user interface system 114 provides a display device to view content. The user interface system 114 includes a hardware interface to connect to an access point 130 that provides a wired and/or a wireless connection for the user interface system. In at least one embodiment, the user interface system 114 comprises a software application that a user downloads and installs on a PED to receive and view content via a wireless access point 130. While bandwidth limitation issues may occur in a wired system on a vehicle, such as an aircraft 132, in general the wired portion of the vehicle information 100A system is designed with enough bandwidth to support all users aboard the vehicle, i.e., passengers.

The user interface system 114 can include an input system (not shown) for permitting the user (or passenger) to communicate with system 100A, such as via an exchange of control signals 138. For example, the input system can permit the user to input one or more user instructions 140 for controlling the operation of system 100A. Illustrative user instructions 140 can include instructions for initiating communication with the content source 113, instructions for selecting viewing content 124 for presentation, and/or instructions for controlling the presentation of the selected viewing content 124. If a fee is required for accessing the viewing content 124 or for any other reason, payment information likewise can be entered via the input system. The input system can be provided in any conventional manner and typically includes a touch screen, application programming interface (API), one or more switches (or pushbuttons), such as a keyboard or a keypad, and/or a pointing device, such as a mouse, trackball, or stylus.

In one aspect, the user interface system 114 is provided on individual passenger seats of aircraft 132. The user interface system 114 can be adapted to different aircraft and seating arrangements and the adaptive aspects described herein are not limited to any specific seat arrangements or user interface types.

FIG. 1B shows an example of implementing the vehicle information system 100B (may be referred to as system 100B) on an automobile 134 that may include a bus, a recreational vehicle, a boat, and/or a train, or any other type of passenger vehicle without limitation. The various components of system 100B may be like the components of system 100A described above with respect to FIG. 1A and for brevity are not described again.

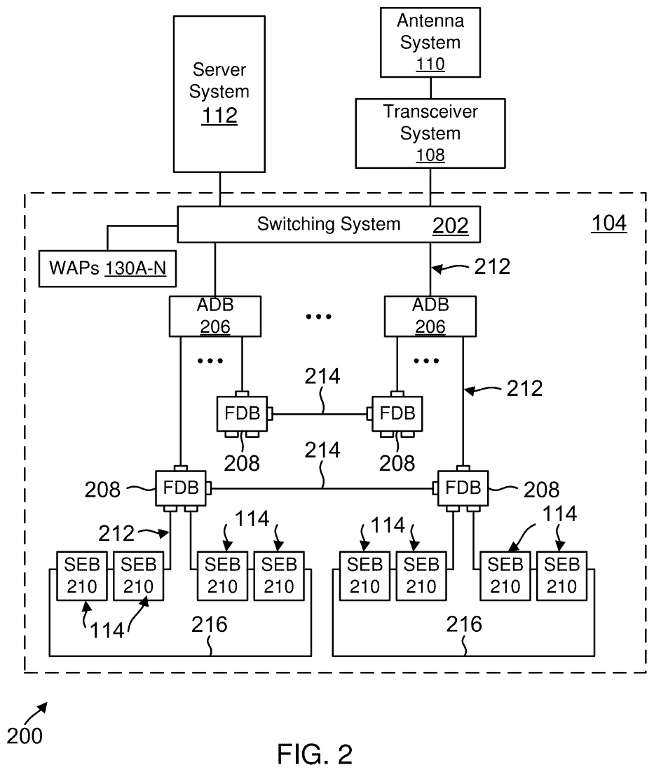

Content Distribution System: FIG. 2 illustrates an example of the content distribution system 104 for the vehicle information system 200 (similar to 100A/100B), according to one aspect of the present disclosure. The content distribution system 104 couples, and supports communication between the server system 112, and the plurality of user interface systems 114. The content distribution system 104, for example, can be provided as a conventional wired and/or wireless communication network, including a telephone network, a local area network (LAN), a wide area network (WAN), a campus area network (CAN), personal area network (PAN) and/or a wireless local area network (WLAN) of any kind. Exemplary wireless local area networks include wireless fidelity (Wi-Fi) networks in accordance with Institute of Electrical and Electronics Engineers (IEEE) Standard 802.11 and/or wireless metropolitan-area networks (MANs), which also are known as WiMax Wireless Broadband, in accordance with IEEE Standard 802.16.

Preferably being configured to support high data transfer rates, the content distribution system 104 may comprise a high-speed Ethernet network, such as any type of Fast Ethernet (such as 100 Base-X and/or 100 Base-T) communication network and/or Gigabit (such as 1000 Base-X and/or 1000 Base-T) Ethernet communication network, with a typical data transfer rate of at least approximately one hundred megabits per second (100 Mbps) or any other transfer rate. To achieve high data transfer rates in a wireless communications environment, free-space optics (or laser) technology, millimeter wave (or microwave) technology, and/or Ultra-Wideband (UWB) technology can be utilized to support communications among the various system resources, as desired.

As illustrated in FIG. 2, the distribution system 104 can be provided as a plurality of area distribution boxes (ADBs) 206, a plurality of floor disconnect boxes (FDBs) 208, and a plurality of seat electronics boxes (SEBs) (and/or video seat electronics boxes (VSEBs) and/or premium seat electronics boxes (PSEBs)) (also referred to as seat boxes) 210 being configured to communicate in real time via a plurality of wired and/or wireless communication connections 212.

The distribution system 104 likewise can include a switching system 202 for providing an interface between the distribution system 104 and the server system 112. The switching system 202 can comprise a conventional switching system, such as an Ethernet switching system, and is configured to couple the server system 112 with the ADBs 206. Each of the ADBs 206 is coupled with, and communicates with, the switching system 202. In addition, the distribution system 104 includes one or more wireless access points (WAPs) (130A to 130N) connected in communication with the switch system 202 for wireless distribution of content to user interface systems 114 including PEDs.

Each of the ADBs 202, in turn, is coupled with, and communicates with, at least one FDB 208. Although the ADBs 206 and the associated FDBs 208 can be coupled in any conventional configuration, the associated FDBs 208 preferably are disposed in a star network topology about a central ADB 206 as illustrated in FIG. 2. Each FDB 208 is coupled with, and services, a plurality of daisy-chains of SEBs 210. The SEBs 210, in turn, are configured to communicate with the user interface systems 114. Each SEB 210 can support one or more of the user interface systems 114.

The switching systems 202, the ADBs 206, the FDBs 208, the SEBs (and/or VSEBs), and/or PSEBs) 210, the antenna system 110 (or 111), the transceiver system 108, the content source 113, the server system 112, and other system resources of the vehicle information system preferably are provided as line replaceable units (LRUs). The use of LRUs facilitate maintenance of the vehicle information system 200 because a defective LRU can simply be removed from the vehicle information system 200 and replaced with a new (or different) LRU. The defective LRU thereafter can be repaired for subsequent installation. Advantageously, the use of LRUs can promote flexibility in configuring the content distribution system 104 by permitting ready modification of the number, arrangement, and/or configuration of the system resources of the content distribution system 104. The content distribution system 104 likewise can be readily upgraded by replacing any obsolete LRUs with new LRUs.

Distribution system 104 can include at least one FDB internal port bypass connection 214 and/or at least one SEB loopback connection 216. Each FDB internal port bypass connection 214 is a communication connection 212 that permits FDBs 208 associated with different ADBs 206 to directly communicate. Each SEB loopback connection 216 is a communication connection 212 that directly couples the last SEB 210 in each daisy-chain of seat electronics boxes 210 for a selected FDB 208 as shown in FIG. 2. Each SEB loopback connection 216 therefore forms a loopback path among the daisy-chained seat electronics boxes 210 coupled with the relevant FDB 208.

It is noteworthy that the various aspects of the present disclosure may be implemented without using FDB 208. When FDB 208 is not used, ADB 206 communicates directly with SEB 210 and/or server system 112 may communicate directly with SEB 210 or the seats. The various aspects of the present disclosure are not limited to any specific network configuration.

System 300: FIG. 3A shows an example of a system 300 configured to operate within an aircraft system (e.g., an onboard management system 344 executing an IFE layer, may also be referred to as the IFE system), according to an aspect. In one aspect, system 300 includes the onboard management system 344 with a server 354, a seat device 326, a seat box 370 (similar to SEB 210), and a crew device (may be referred to as “CMD”) 360, when authorized. In yet another aspect, system 300 includes the CMD 360 and the seat device 326 or the CMD 360 and the seat device 326 and the seat box 370, respectively.

In one aspect, the onboard management system 344 includes server 354 (similar to the media server 112 and/or computer system 106/107 described above with respect to FIG. 1A/1B). The server 354 includes a processor 346 that has access to a memory 350 via a bus system/interconnect (similar to 312 on seat device 326). The bus system may represent any one or more separate physical buses and/or point-to-point connections, connected by appropriate bridges, adapters and/or controllers. The bus system may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

Processor 346 may be, or may include, one or more programmable, hardware-based, general-purpose or special-purpose microprocessors, digital signal processors (DSPs), programmable controllers, application specific integrated circuits (ASICs), programmable logic devices (PLDs), or the like, or a combination of such devices.

Processor 346 has access to a storage device 342 that may be used to store data (for example, passenger data 352, applications and program files, including system software 356, application 314, and others. In one aspect, system software 356 is executed by processor 346 to control the overall operation of the server 354.

In one aspect, the onboard management system 344 maintains flight and passenger data 352 (may also be referred to as data 352), for example, flight itinerary including origin location, layover locations, destination location, arrival time and other information. Data 352 may also include passenger data that identifies each passenger for a flight, a seat assigned to a passenger, a language preference for the passenger, and any other information that can uniquely identify the passengers. Data 352 may be retrieved from a ground system before flight departure.

In one aspect, server 354 communicates with CMD 360, seat device 326, and/or seat box 370 via the communication interface 358. The communication interface 358 may also be used to receive information from the ground, for example, data 352 and other information. The communication interface 358 includes one or more interfaces for a wired and/or wireless connection, as described above with respect to FIGS. 1A/1B and 2.

In one aspect, seat device 326 includes a display device 330, a processor 332, a memory 340, a seat device communication interface (also referred to as communication interface) 328 and a local storage device 342 for storing content. The seat device may optionally include a camera 337 and a microphone 336. The camera may be used to take pictures and videos and the microphone may be used for receiving voice input.

In one aspect, the seat device 326 receives user input/requests via an input module 338. The input module 338 may be configured to use a local touch screen included with display 330, a local virtual keyboard, an external mouse, external keyboard or any other input device.

In one aspect, processor 332 has access to memory 340 via an interconnect 312. Processor 332 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The bus system 312 is an abstraction that represents any one or more separate physical buses and/or point-to-point connections, connected by appropriate bridges, adapters and/or controllers. The bus system 312, therefore, may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

In one aspect, processor 332 executes an IFE layer 334 out of memory 340. The IFE layer 334 provides in-flight entertainment and other options for users. The IFE layer 334 provides audio/video content as well as controls for accessing the content.

In one aspect, the IFE layer 334 uses the seat device communication interface 328 to interface with the seat box 370 and/or onboard management system 344. The communication interface 328 includes logic and circuitry for interfacing with the onboard management system 344 and/or seat box 370. In one aspect, the communication interface 328 may use a wireless and/or wired connection for such communication.

In another aspect, the seat device 326 may also execute the application 314 that may be used by the passenger to view media content or various computing functions that are enabled by the seat device 326.

The seat device 326 on the aircraft may be part of the user interface system 114 or interfaces with the user interface system 114 also described above with respect to FIG. 1A/1B. It is noteworthy that seat device 326 need not be mounted on the back of a seat and may be supported from other structures, such as a bulkhead, wall, arm of a seat, etc. The adaptive aspects of the present disclosure are not limited to any specific location or orientation of the seat device 326.

In one aspect, server 354 communicates with the CMD 360 that may be a mobile phone, a notebook, a tablet, a laptop or any other similar device. CMD 360 may include a processor 362 that has access to a memory 364 via a bus system/interconnect (similar to 312) for executing stored instructions. The bus system may represent any one or more separate physical buses and/or point-to-point connections, connected by appropriate bridges, adapters and/or controllers. The bus system may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

Processor 362 may be, or may include, one or more programmable, hardware based, general-purpose or special-purpose microprocessors, digital signal processors (DSPs), programmable controllers, application specific integrated circuits (ASICs), programmable logic devices (PLDs), or the like, or a combination of such hardware devices.

In one aspect, CMD 360 includes a display 322 to display information. Display 322 may also include a touch screen for receiving input commands. CMD 360 typically includes a microphone (not shown) for receiving voice input. CMD 360 may also include a camera (not shown) for taking pictures or making a video. The CMD 360 may also include a storage device 324 that may include any storage medium for storing data in a non-volatile manner, such as one or more magnetic or optical based disks, flash memory, or solid-state drive. The storage device 316 may be used to store a device interface 318, may also be referred to as a “crew management interface (CMI)” 318 that may be executed out of memory 364.

The CMI 318 enables the CMD 360 to interface with the onboard management system 344 via a CMD communication module 366. The CMD 360 may present one or more APIs to the onboard management system 344 to retrieve passenger/flight data and update data structure 352. The non-limiting API format and syntax will depend on the protocols used by the CMD 360 and the onboard management system 344.

In one aspect, the CMD communication module 366 is also used to communicate with the seat device 326, when installed, and/or the seat box 370. CMI 320 receives information regarding one or more seat attributes that do not meet take-off and/or landing conditions. CMI 320 notifies the seat device directly and/or via the seat box 370 if a passenger needs to take action (e.g., move the passenger seat, tray table, window or any other action.

In one aspect, the CMD communication module 366 may include one or more interfaces to communicate with different devices, including Wi-Fi interface, Bluetooth interface, NFC (Near Field Communication) interface and others. The adaptive aspects described herein are not limited to any specific interface. It is noteworthy that although a single block is shown for the CMD communication module 366 for convenience, the communication module may have different interface, cards, logic and circuitry to comply with the different communication protocols/standards.

The seat box 370 uses a seat box communication interface 381 to communicate with the seat device 326 and/or CMD 360. For example, data may be communicated from the CMD 360 to the seat box 370 via the seat box communication interface 381, and the data may be transmitted to the seat device 325 via the seat box communication interface 381. In one aspect, seat box communication interface 381 includes a communication interface for data communication with the onboard management system 344 and/or the seat device 326. In one aspect, the communication interface 381 may use a wireless and/or wired connection for such communication. In one aspect, the communication interface 381 may include a fiber optic communication interface. The adaptive aspects described herein are not limited to any specific interface. It is noteworthy that the communication interface 381 may have different interface, cards, logic and circuitry to comply with the different communication protocols/standards.

In an example, the seat box 370 may include a processor 372 that has access to a memory 374 via a bus system/interconnect (similar to 312 on the seat device 326) for executing stored instructions. The bus system may represent any one or more separate physical buses and/or point-to-point connections, connected by appropriate bridges, adapters and/or controllers. The bus system may include, for example, a system bus, a Peripheral Component Interconnect (PCI) bus, a PCI-Express bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

The seat box 370 may further include a power supply component include a power supply component 378 that supplies power to the seat box 370 and controls power supplied to another device. For example, the power supply component 378 may include an AC-to-DC converter to convert alternating current (AC) power to direct current (DC) power, to supply the DC power to the seat device 326.

Processor 306 may be, or may include, one or more programmable, hardware based, general-purpose or special-purpose microprocessors, digital signal processors (DSPs), programmable controllers, application specific integrated circuits (ASICs), programmable logic devices (PLDs), or the like, or a combination of such hardware devices.

In an example, the seat box 370 includes a storage device 376 that may be or may include any storage medium for storing data in a non-volatile manner, such as one or more magnetic or optical based disks, flash memory, or solid-state drive. In one aspect, the storage device 376 may store information or data received from the server 354. In an example, the storage device 376 may be used to store content to be displayed on display 330 of the seat device 326.

FIG. 3B shows an example of seat boxes receiving data and electric power, according to one aspect. Each of the seat boxes 370A, 370B, and 370C in FIG. 3B may have the same or similar features as the seat box 370 shown in FIG. 3A. Further, the server 354 in FIG. 3B may be the server 354 shown in FIG. 3A. Each of the seat boxes 370A, 370B, and 370C is configured to receive data communication and electric power. In particular, the server 354 transmits data, which is received by a first communication interface component 382A of the seat box 370A. The seat box 370A may transmit this data via a second communication interface component 383A, which is received by a first communication interface component 382B of the seat box 370B. The seat box 370B may transmit this data via a second communication interface component 383B, which is received by a first communication interface component 382C of the seat box 370C. The seat box 370C may have a second communication interface component 383C for transmitting data, although FIG. 3B does not show the second communication interface component 383C being utilized.

A transportation vehicle may also include a power generator 390 to provide electric power to various devices, including the seat boxes 370A, 370B, and 370C. The power generator 390 may be associated with an engine of the transportation vehicle to generate electric power. In an aspect, the power generator 390 may provide AC power. In some aspects, each of the seat boxes 370A, 370B, and 370C may be connected to seat device(s) (with the similar features to the seat device 326) to provide data and electric power and may provide DC power to the seat device(s), where the DC power is achieved by converting the AC power to the DC power (e.g., via the AC-to-DC converter).

The electric power provided by the power generator 390 is received by a first power interface component 386A of the seat box 370A. The seat box 370A may provide this electric power via a second power interface component 387A of the seat box 370A, which may be received by a first power interface component 386B of the seat box 380B. The seat box 370B may further provide the electric power via a second power interface component 387B of the seat box 370B, which may be received by a first power interface component 386C of the seat box 380C. The seat box 370C may have a second power interface component 387C for transmitting data, although FIG. 3B does not show the second power interface component 387C being utilized.

Different approaches exist for providing the data communication and the electric power from the server 354 and the power generator 390 to one or more of the seat boxes 370A, 370B, and 370C. According to one approach, separate cables and connectors may be used for the data communication and the electric power. For example, a cable with a connector for data communication is used to communicate data to one or more of the seat boxes 370A, 370B, and 370C, while another cable with a different connector for electric power may be used to supply electric power to one or more of the seat boxes 370A, 370B, and 370C. To communicate data, ethernet technology is generally utilized, and thus an ethernet cable and an ethernet connector may be used to communicate data.

In another approach, a cable and a connector that provides both the ethernet connection for data communication and power connections to supply electric power may be used. In this approach, instead of using separate cables/connectors for data communication and electric power, a single cable may be connected to a single connector at the seat box. As such, a less number of cables and a less number of connectors may be used when a connector providing both an ethernet interface and a power interface is used.

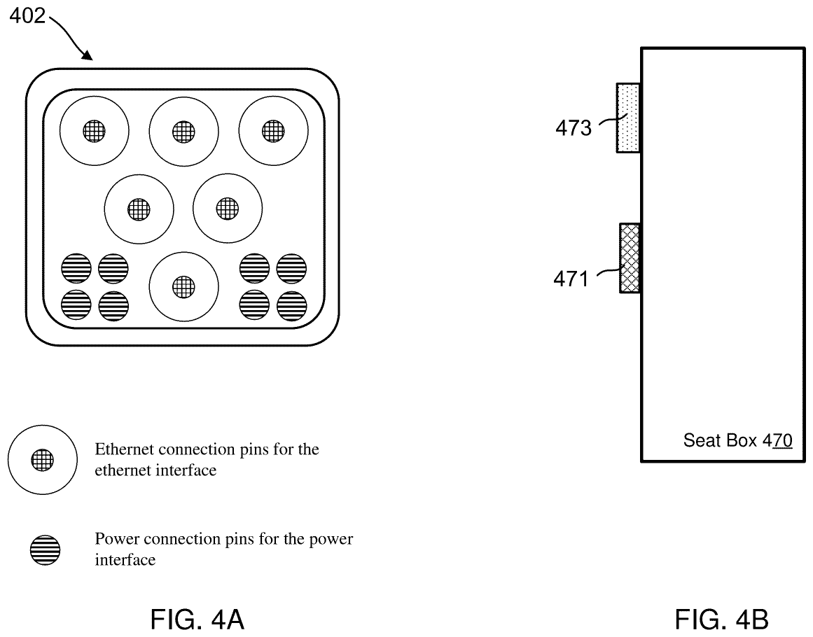

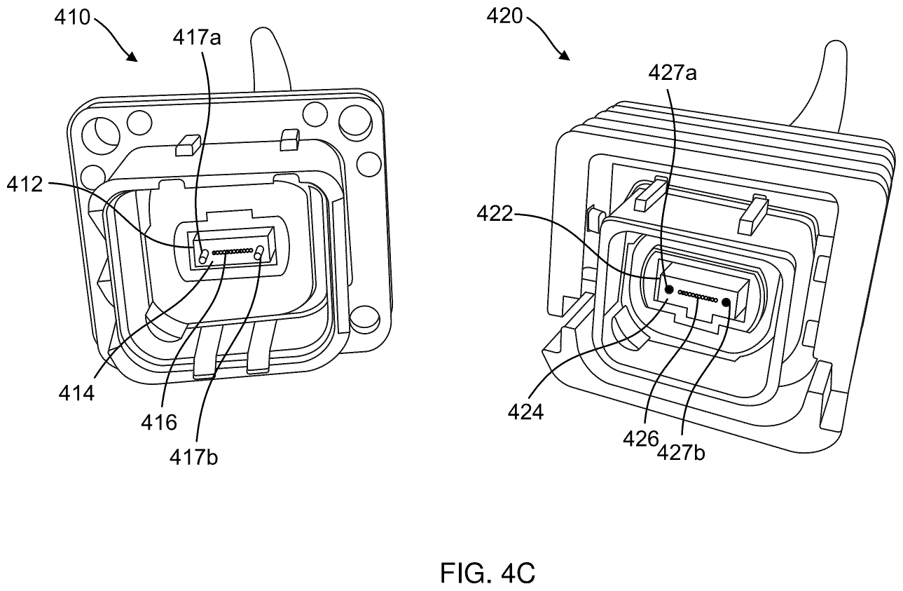

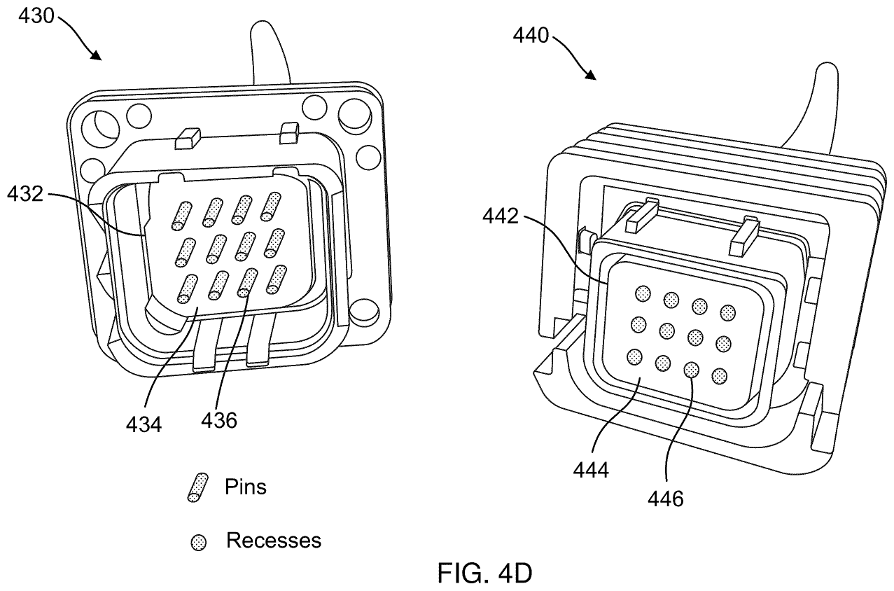

FIG. 4A shows a front view of a connector having an ethernet interface and a power interface, according to some aspects. As shown in FIG. 4A, a connector 402 may include data connections for the ethernet interface and power connections for the power interface. As shown in FIG. 4A, the ethernet interface takes up more than half of the space of the connector 402, while the power connections for the power interface are provided on the bottom left corner and on the bottom right corner.

FIG. 4B is an example diagram showing a seat box with at least one connector having an ethernet interface and a power interface, according to some aspects. A seat box 470 as shown in FIG. 4B may include similar features to the seat box 370 of FIG. 3A. The seat box 470 includes a first connector 471 that includes an ethernet interface to receive data communication and a power interface to receive electric power. In some aspects, the seat box 470 may also include a second connector 473 that includes an ethernet interface to transmit data to another device such as another seat device and a power interface to provide the electric power to another device such as another seat device.

Data communication via ethernet has been suitable for many years when a size of data communicated via ethernet within a transportation was not high. However, a larger size of data is being communicated more often recently, e.g., to provide higher quality data to passengers. For example, to communicate data to provide an ultra-high definition (UHD) quality videos, an interface and a connection that provide a higher bandwidth is needed. Unfortunately, the ethernet technology is not capable of handling such a high bandwidth capacity. A fiber optic technology may provide higher capacity than the ethernet technology and thus may be capable of communicating UHD videos. Further, the ethernet technology is subject to electromagnetic interference and thus having power connections nearby ethernet connections may cause electromagnetic interference. To reduce the electromagnetic interference, special shielding is usually needed to shield the ethernet connections from the power connections, which can be cumbersome and add to the total cost. On the other hand, the fiber optic technology is generally not affected by electromagnetic interference. Even with these benefits of fiber optic connections, using the fiber optic technology was costly in the past and thus was not widely used, especially in transportation vehicles that require more than a few fiber optic cables.

More recently, the cost of fiber optic cable has been decreasing, and with the demand for the high bandwidth capacity (e.g., for UHD videos), the fiber optic technology is starting to become a preferred approach to communicate data in some situations. Hence, use of the fiber optic technology within transportation vehicles is being considered. Additionally, it is anticipated that some of the upcoming network systems may prefer a multi-fiber fiber optic technology utilizing multiple optical fibers per cable, for data communication within transportation vehicles.

FIG. 4C is an example diagram showing connectors having multi-fiber fiber optic interfaces, according to some aspects. In particular, FIG. 4C shows a male connector 410 having a fiber optic interface component 412 providing a multi-fiber fiber optic interface 414 with multiple fiber optic connections 416 for data communication. The fiber optic interface component 412 may further include guide pins 417a and 417b. FIG. 4C also shows a female connector 420 that corresponds to the male connector 410, where the female connector 420 has a fiber optic interface component 422 providing a multi-fiber fiber optic interface 424 with multiple fiber optic connections 426 for data communication that correspond to the fiber optic connections 416 of the male connector 410. When the male connector 410 couples with the female connector 420, the fiber optic connections 416 of the male connector 410 couples with the fiber optic connections 426 of the female connector 420, respectively, to enable data communication between the male connector 410 and the female connector 420, and the guide pins 417a and 417b of the male connector 410 are inserted into guide recesses 427a and 427b of the female connector 420. In the example shown in FIG. 4C, the male connector 410 and the female connector 420 are connectors based on the EN4165 standard, which is widely used for connectors in transportation vehicles.

A connector for providing a multi-fiber fiber optic connection generally includes only a fiber optic interface, without any other connection interfaces, as shown in FIG. 4C, for example. However, a multi-fiber fiber optic interface such as a Multi-fiber Push On (MPO) interface and a Multi-Fiber Termination Push-On (MTP) interface generally takes up only a small area in a connector. For example, as shown in FIG. 4C, the fiber optic connections 416 takes up less than one third of the space available on the fiber optic interface 414. Therefore, the area in a connector that is not used by the multi-fiber fiber optic interface may be explored to utilize for another type of interface, such as a power interface for providing AC electric power.

FIG. 4D is an example diagram showing connectors having power connections for supplying electric power, according to some aspects. In particular, FIG. 4D shows a male connector 430 having a power interface component 432 providing a power interface 434 with 12 connection pins as power connections 436 to deliver AC electric power such as three-phase electric power with three AC phases. The power connections 436 may be used to receive or send the AC electric power. FIG. 4D also shows a female connector 440 corresponding to the male connector 430 and having a power interface component 442 providing a power interface 434 with 12 recesses as power connections 446 to deliver AC electric power. The 12 recesses of the power connections 436 of the female connector 440 correspond to the 12 connection pins of the power connections 436 of the male connector 430. Hence, when the male connector 430 and the female connector 440 are coupled together, the 12 connection pins of the power connections 436 are inserted into the 12 recesses of the power connections 446, respectively, and thus the power connections 436 and the power connections 446 become electrically connected to each other to deliver power between the male connector 430 and the female connector 440. In the example shown in FIG. 4D, the male connector 430 and the female connector 420 are connectors based on the EN4165 standard.

If one type of connectors is used for data communication and a separate type of connectors is used to deliver electric power, then a cable for data communication and another cable for electric power are used to provide data communication and electric power a seat box, and thus two cables are used for data and power. Considering that many transportation vehicles such as aircrafts have numerous seats and thus have numerous seat boxes, the number of cables used for these seat boxes become high and the weight of the cables become high as a result. Therefore, using two separate cables for data and power may not be desirable in a transportation vehicle. Further, it is desirable to reduce a number of connectors used for a seat box to reduce a volume and weight of the seat box. Therefore, a connector that can provide both the data communication and the electric power is desired, such that a hybrid cable that can carry both the data communication and the electric power can be used in conjunction with the hybrid connector. Additionally, a hybrid connector with multi-fiber fiber optic interface is desirable over the ethernet connection, because the multi-fiber fiber optic interface is capable of handling high-bandwidth data communication, such as the UHD video data, while avoiding effects from electromagnetic interferences. However, a hybrid connector with the multi-fiber fiber optic interface and a power interface for delivering a three-phase AC electric power has not yet been developed.

According to some aspects of the disclosure, a hybrid connector for a seat box of a transportation vehicle includes a power interface component providing a power interface via power connections to receive or send three-phase electric power with three AC phases (e.g., Phases A, B, and C) and further includes a fiber optic interface component providing a fiber optic interface with multiple fiber optic connections. In this hybrid connector, the power connections included in the power interface component are configured to deliver the three-phase electric power for the seat box, while the multiple fiber optic connections included in the fiber optic interface component are configured for data communication via multiple optical fibers. The hybrid connector also includes a housing that includes a single hybrid interface providing the power interface of the power interface component and the fiber optic interface of the fiber optic interface component. Here, the housing is configured to house the power interface component and the fiber optic interface component.

In the hybrid connector of the present disclosure, load interferences between power connections and fiber optic connections may be kept minimal even if the power connections and the fiber optic connections are within the same connector or the same cable because fiber optic connections are not electrical conductor and thus are not affected by electromagnetic interferences. On the other hand, when power connections and ethernet connections exist within the same connector (as shown in FIG. 4A) or the same cable, this combination of the power connections and the ethernet connections within the same connector is subjected to electromagnetic interferences. Therefore, the hybrid connector with the power interface component and the fiber optic interface component are more beneficial than a hybrid connector having the ethernet interface and the power interface, because the hybrid connector with the power interface component and the fiber optic interface component allows high capacity data communication with much less interferences.

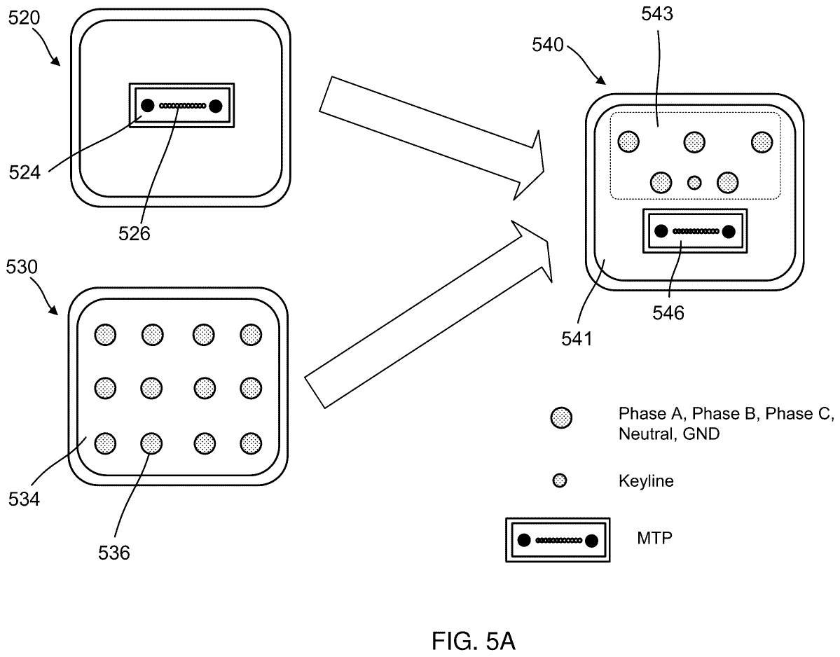

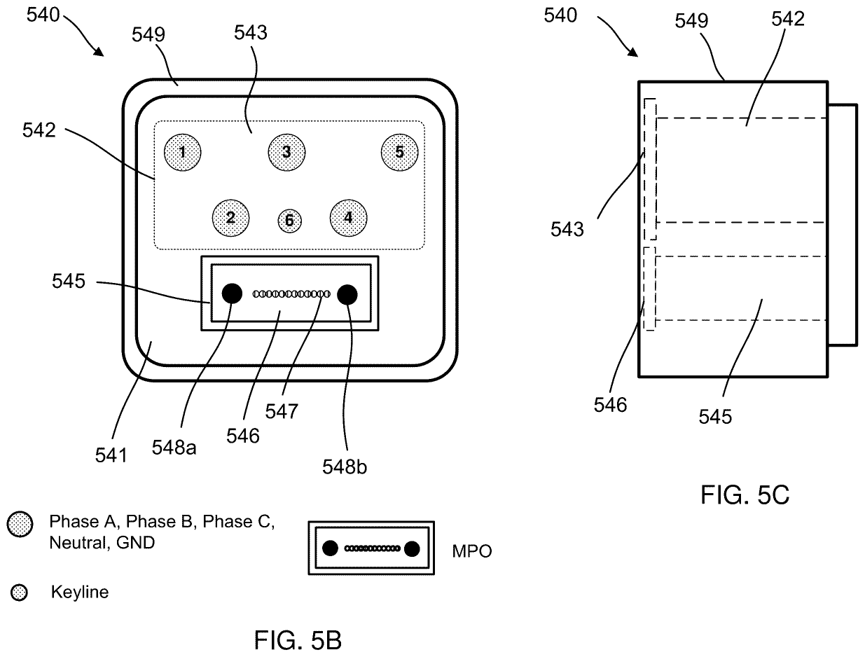

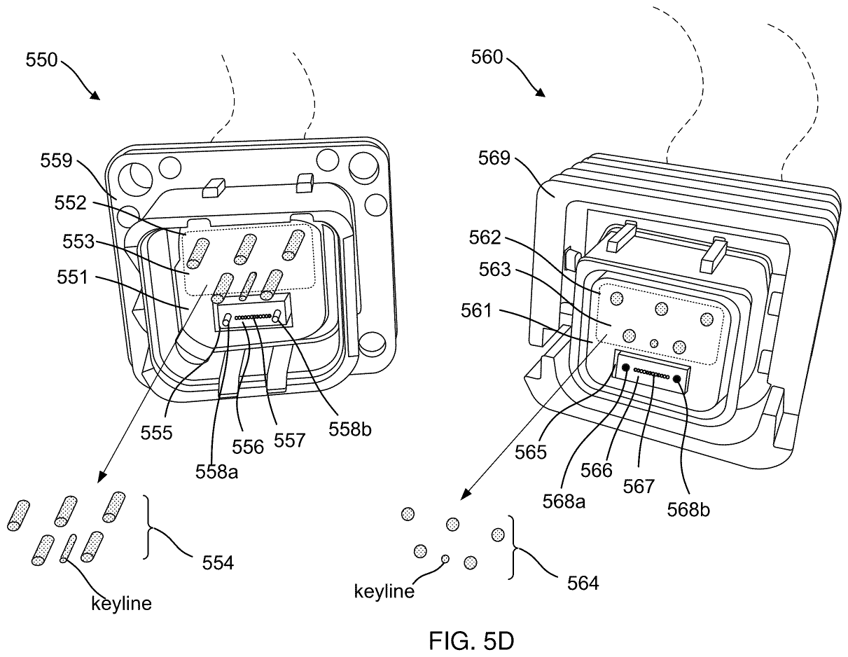

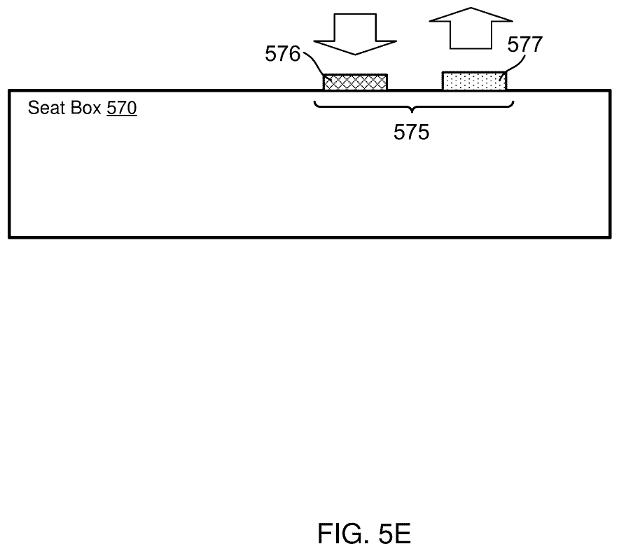

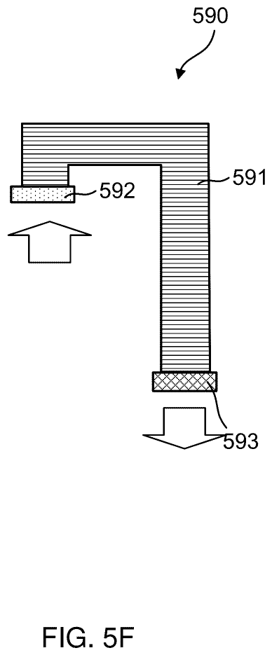

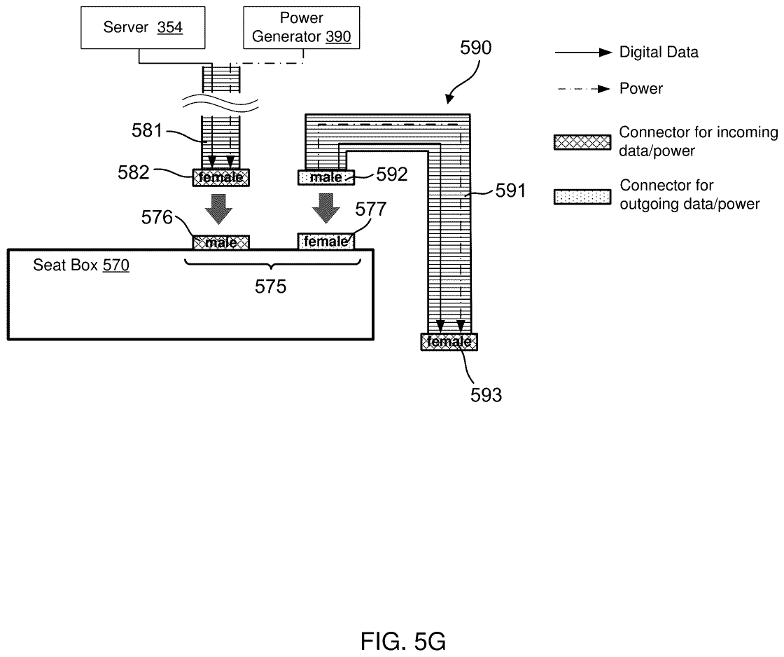

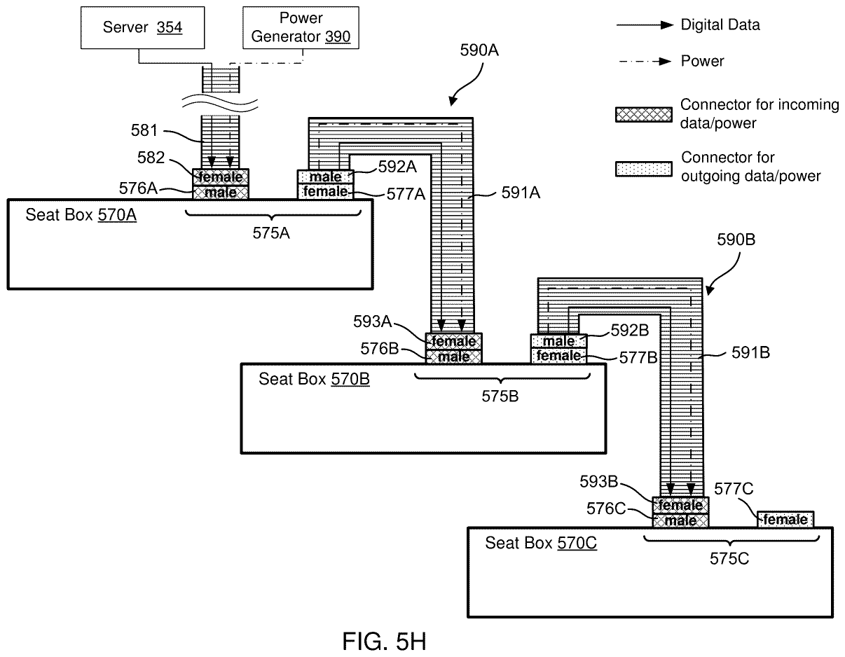

FIG. 5A shows an example showing a combination of a multi-fiber fiber optic interface and a power interface to form a hybrid connector for a seat box of a transportation vehicle to provide a hybrid interface with a power interface and a multi-fiber fiber optic interface, according to an aspect of the present disclosure. As shown in FIG. 5A, a hybrid connector 540 for a seat box of a transportation vehicle has a hybrid interface 541 providing a power interface 543 with multiple power connections to receive or send three-phase electric power with three AC phases and also providing an fiber optic interface 546 with multiple fiber optic connections to receive or send data. The hybrid connector 540 shown in FIG. 5A is a female connector, and a corresponding male connector may connect to this female connector, as explained below. The hybrid interface 541 shown in FIG. 5A may be an EN4165 connector or an AIRINC 809 connector. Additional details about the hybrid connector 540 are provided below in reference to FIGS. 5B and 5C.

As shown in the example of FIG. 5A, the hybrid connector 540 with the hybrid interface 541 may be achieved by combining a fiber optic interface 524 of a fiber optic connector 520 with multiple fiber optic connections 526 and a power interface 534 of a power connector 530 with multiple power connections 536. The fiber optic interface 524 may be similar to the fiber optic interface 424 of FIG. 4C and the power interface 534 may be similar to the power interface 444 of FIG. 4D. In a connector with a power interface component having multiple power connections to deliver AC electric power, the power connections generally take up most of the area of the power interface, which makes it difficult to combine the power interface with the multi-fiber fiber optic interface. For example, as shown in the power interface 534, 12 power connections 536 take up the most of the area of the power interface 534, which is also similarly shown in FIG. 4A. However, the number of the power connections may be reduced to a minimum necessary number of power connections, such that the reduced number of power connections may take up less space on an area of an interface for a connector while maintaining sufficient distance from one another.

Hence, in some aspects, the number of the power connections in the hybrid connector may be no more than 6. In particular, the power connections in the hybrid connector may be a first AC power connection for a first phase (Phase A) AC power, a second AC power connection for a second phase (Phase B) AC power, a third AC power connection for a third phase (Phase B) AC power, a ground connection, a neutral connection, and a keyline connection. In this aspect, the keyline connection is the smallest in size among the power connections of the hybrid connector. For example, as shown in FIG. 5A, the power interface 543 of the hybrid connector 540 has 6 power connections, where 5 power connections with a larger size are a Phase A AC power connection, a Phase B AC power connection, a Phase C AC power connection, a ground connection, and a neutral connection, and 1 power connection with a smaller size is a keyline connection.

A keyline connection may be used to communicate a varying DC voltage that is interpreted by the seat box when to take a certain action. For example, in an emergency situation, the DC voltage at the keyline may be changed to a different DC voltage that signals the seat box to shut off. Hence, the keyline connection does not need to handle a high current, and thus can be made smaller than the other power connections. Therefore, in some aspects, the keyline connection at the hybrid connector of the disclosure may be smaller than the other 5 power connections, which is also shown in FIG. 5A, for example. By making the keyline connection smaller, this allows a more space for the power connections and also more spacing between the other 5 power connections including the first AC power connection, the second AC power connection, the third AC power connection, the ground connection, and the neutral connection.

In some aspects, the hybrid interface of the hybrid connection may be a non-concentric interface with a first half of an area of the hybrid interface being configured for the power interface and a second half of the area of the hybrid interface being configured for the fiber optic interface. For example, as shown in FIG. 5A, the hybrid interface 541 is a non-concentric interface in a rectangular shape with rounded edges, where the top half of the area of the hybrid interface 541 is configured for the power interface 543, and the bottom half of the area of the hybrid interface 541 is configured for the fiber optic interface 546.

FIG. 5B shows an enlarged front view of the hybrid connector 540 of FIG. 5A, according to an aspect of the present disclosure. As shown in FIG. 5B, the hybrid connector 540 includes a power interface component 542 including power connections 1 through 6 that are configured to deliver three-phase electric power with three AC phases for the seat box. The power interface component 542 is configured to provide the power interface 543 via the power connections 1 thorough 6 to receive or send the three-phase electric power. Further, as shown in FIG. 5B, the hybrid connector 540 includes a fiber optic interface component 545 including the multiple fiber optic connections 547 configured for data communication via multiple optical fibers. The fiber optic interface component 545 is configured to provide the fiber optic interface 546 via the multiple fiber optic connections 547 to receive or send data. In the example shown in FIG. 5B, the multiple fiber optic connections 547 have 12 fiber optic connections. However, the number of fiber optic connections is not limited to 12. In another example not shown in FIG. 5B, there may be 8 fiber optic connections in a fiber optic interface. In the example of FIG. 5B, the fiber optic interface 546 may also have guide recesses 548a and 548b, to couple with guide pins of a corresponding male hybrid connector.

In FIG. 5B, the power connections in the power interface 543 of the hybrid connector 540 are assigned with numbers 1 through 6 for ease of reference. As shown in FIG. 5B, the power connections 1 through 5 may be used for the first AC power connection (e.g., for Phase A), the second AC power connection (e.g., for Phase B), the third AC power connection (e.g., for Phase C), the ground connection, and the neutral connection. The positions of these 5 power connections may be in any order. For example, as shown in FIG. 5B, two adjacent connections of these 5 power connections may be spaced from each other by the same distance.

FIG. 5C shows a side view of the hybrid connector 540 of FIG. 5A and FIG. 5B, according to an aspect of the present disclosure. As shown in FIG. 5C, the hybrid connector 540 includes a power interface component 542 including the power connections 1 through 6 shown in FIG. 5B, where the power interface component 542 is configured to provide the power interface 543 via the power connections 1 thorough 6 to receive or send the three-phase electric power. Further, as shown in FIG. 5C, the hybrid connector 540 includes a fiber optic interface component 545 including the multiple fiber optic connections 547 shown in FIG. 5B, where the fiber optic interface component 545 is configured to provide the fiber optic interface 546 via the multiple fiber optic connections 547 to receive or send data.

In an example, the power connections 1 through 6 may be connected to six separate conductive power lines such as copper or brass wires in the power interface component 542, and the multiple fiber optic connections 547 may be connected to the multiple optical fibers in the fiber optic interface component 545. In this example, the six conductive power lines and the multiple optical fibers may be connected to various portions of a seat box or may be run as a cable coming out of the hybrid connector 540.

Further, as shown in FIG. 5B and FIG. 5C, the hybrid connector 540 further includes a housing 549 configured to house the power interface component and the fiber optic interface component. The housing 549 includes the hybrid interface 541 providing the power interface 543 of the power interface component 542 and the fiber optic interface 546 of the fiber optic interface component 545. As shown in FIG. 5B, only the single hybrid interface 541 may be provided to provide the power interface 543 and the fiber optic interface 546.

In some aspects, two adjacent connections of the first AC power connection, the second AC power connection, the third AC power connection, the ground connection, and the neutral connection are spaced from each other by the same distance. Because these 5 power connections are the power connections associated with providing the AC power, sufficient distancing between two adjacent connections is desired to minimize any load interference. By keeping the distance of two adjacent connections of these 5 power connections equal, a maximum distance may be achieved between two adjacent connections of these 5 power connections.

For example, as shown in FIG. 5B, the distance between the power connections 1 and 2, the distance between the power connections 1 and 3, the distance between the power connections 2 and 3, the distance between the power connections 2 and 4, the distance between the power connections 3 and 4, the distance between the power connections 3 and 5, the distance between the power connections 4 and 5 are the same. The power connection 6 is the smallest in size among the power connections 1 through 6, and is the keyline connection. Because the keyline connection does not handle a high current, interferences from the keyline connection is small. Therefore, the keyline connection may be placed between the power connections 2 and 4 without causing much interferences.

In some aspects, a distance between the keyline connection and at least one of the power connections that is adjacent to the keyline connection may be different from a distance between the keyline connection and another one of the power connections that is adjacent to the keyline connection. For example, as shown in FIG. 5B, the distance between the power connection 2 and the power connection 6 being the keyline connection is different from the distance between the power connection 3 and the power connection 6.

In some aspects, the multiple fiber optic connections may include more than two fiber optic connections arranged linearly. For example, as shown in FIG. 5B, the multiple fiber optic connections 547 include 12 fiber optic connections arranged linearly. As shown in the example of FIGS. 5A and 5B, the fiber optic interface 548 may be an MTP or an MPO connection interface with the fiber optic connections and 2 guide pins. It is noted that the disclosure is not limited to the example shown in FIG. 5B, and thus the multiple fiber optic connections may include a different number of fiber optic connections in another example.

In some aspects, the hybrid interface may be configured to couple with an opposing hybrid interface of an opposing hybrid connector with an opposing power interface for the three-phase electric power and an opposing fiber optic interface for the data communication. For example, the hybrid interface 541 of the hybrid connector 540 shown in the example of FIGS. 5A and 5B is a female hybrid interface of a female hybrid connector configured to couple with a male hybrid interface of a male hybrid connector with a male power interface and a male fiber optic interface.

FIG. 5D shows an example male hybrid connector and an example female hybrid connector for a seat box of a transportation vehicle, according to an aspect of the present disclosure. In FIG. 5D, a female hybrid connector 560 may be an example of the hybrid connector 540 of FIGS. 5A, 5B, and 5C, while a male hybrid connector 550 has connections and structures corresponding to those of the female hybrid connector 560 to couple with the female hybrid connector 560. The male hybrid connector 550 and the female hybrid connector 560 shown in FIG. 5D may be EN4165 connectors. In the example of FIG. 5D, the male hybrid connector 550 includes a power interface component 552 that has 6 pins as power connections 554 for delivering three-phase electric power with three AC phases for a seat box. The power interface component 442 provides a power interface 553 via the power connections 554 to receive or send the three-phase electric power. The male hybrid connector 550 further includes a fiber optic interface component 555 that has multiple fiber optic connections 557 configured for data communication via multiple optical fibers. The fiber optic interface component 555 is configured to provide a fiber optic interface 556 via the multiple fiber optic connections 557 to receive or send data. The male hybrid connector 550 also includes a housing 559 configured to house the power interface component 552 and the fiber optic interface component 555. The housing 559 includes a single hybrid interface 551 providing the power interface 553 and the fiber optic interface 556. In some aspects, the power connections 1 through 6 may be connected to electric wires and the fiber optic connections 547 may be connected to optical fibers, such that a cable connected to the hybrid connector 540 may include both the electric wires and the optical fibers.

As shown in FIG. 5D, the female hybrid connector 560 includes a power interface component 562 that has 6 pins as power connections 564 for delivering three-phase electric power with three AC phases for a seat box. The power interface component 442 provides a power interface 563 via the power connections 564 to receive or send the three-phase electric power. The female hybrid connector 560 further includes a fiber optic interface component 565 that has multiple fiber optic connections 567 configured for data communication via multiple optical fibers. The fiber optic interface component 565 is configured to provide a fiber optic interface 566 via the multiple fiber optic connections 567 to receive or send data. The female hybrid connector 560 also includes a housing 569 configured to house the power interface component 562 and the fiber optic interface component 565. The housing 569 includes a single hybrid interface 561 providing the power interface 563 and the fiber optic interface 566.

As shown in FIG. 5D, the male hybrid connector 550 may be coupled to the female hybrid connector 560, such that the 6 pins of the power connections 554 of the male hybrid connector 550 may be inserted into the 6 recesses of the power connections 564 of the female hybrid connector 560 to come into respective electrical contacts with one another, and that the guiding pins 558a and 558b may be inserted into guiding recesses 568a and 568b to guide the fiber optic connections 557 of the male hybrid connector 550 to come in contact with the fiber optic connections 567 of the female hybrid connector 560.

As discussed above, the hybrid connector described above provides high-capacity multi-fiber fiber optic connections and power connections in a single hybrid interface, while minimizing any interferences among the multi-fiber fiber optic connections and the power connections. When the hybrid connector described above is used to provide both the power connections and the fiber optic connections, a less number of connectors are needed for a seat box or for a cable than when a power connector and a fiber optic connector are used separately. Therefore, each seat box would weigh less with the hybrid connector. This weight reduction in the seat box is beneficial especially in a transportation vehicle that has numerous seat boxes for numerous seats, as the cumulative reduction of the weight of the seat box is significant. Further, because the hybrid connector allows less number of connectors in each seat box or each cable, total cost associated with the connectors may be reduced. Additionally, when the hybrid connector is used, a less number of cables and a less number of power connections are used than when a power connector and a fiber optic connector are used separately.

The hybrid connector described above may be utilized in various components in a transportation vehicle. According to some aspects of the disclosure, one or more of the hybrid connector discussed above may be implemented at a seat box and may be implemented at a cable to connect to the seat box. An aspect of the disclosure includes a hybrid connector set to be implemented at a seat box, where the hybrid connector set includes a first hybrid connector configured to receive power and data and a second hybrid connector configured to relay the power and the data received via the first hybrid connector to a different seat box. In an example, the first hybrid connector and the first hybrid connector may be directly attached together to form the hybrid connector set or may be attached to a plate or an additional structure to form the hybrid connector set.

Each of the hybrid connectors in the hybrid connector set may include similar features of the hybrid connector described above. In particular, the first hybrid connector includes a first power interface component providing a first power interface via first power connections to receive the three phase electric power with three AC phases. The first hybrid connector further includes a first fiber optic interface component providing a first fiber optic interface via multiple first fiber optic connections to receive data communication. In the first hybrid connector, the first power connections included in the first power interface component are configured to receive the three-phase electric power for the seat box, while the multiple first fiber optic connections included in the fiber optic interface component are configured to receive the data communication via multiple first optical fibers. The first hybrid connector also includes a first housing configured to house the first power interface component and the first fiber optic interface component, where the first housing includes a single first hybrid interface providing the first power interface and the first fiber optic interface.

The second hybrid connector includes a second power interface component providing a second power interface via second power connections to send the three phase electric power with three AC phases to the different seat box. The second hybrid connector further includes a second fiber optic interface component providing a second fiber optic interface via multiple second fiber optic connections to send data communication to the different seat box. In the second hybrid connector, the second power connections included in the second power interface component are configured to send the three-phase electric power to the different seat box, while the multiple second fiber optic connections included in the fiber optic interface component are configured to send the data communication to the different seat box via multiple second optical fibers. The second hybrid connector also includes a second housing configured to house the second power interface component and the second fiber optic interface component, where the second housing includes a single second hybrid interface providing the second power interface and the second fiber optic interface.

In an aspect, the first hybrid connector of the hybrid connector set may be a male connector and the second hybrid connector of the hybrid connector set may be a female connector. For example, the first hybrid connector of the hybrid connector set may be the male hybrid connector 550 of FIG. 5D and the second hybrid connector of the hybrid connector set may be the female hybrid connector 560 of FIG. 5D.

In some aspects, the first fiber optic interface may be an MPO connection interface or an MTP connection interface. In some aspects, the second fiber optic interface may be an MPO connection interface or an MTP connection interface. For example, as shown in FIG. 5D, the male hybrid connector 550 has an MPO connection interface as the fiber optic interface 556 and the female hybrid connector 560 has an MPO connection interface as the fiber optic interface 566.

In some aspects, the first hybrid connector may be an EN4165 connector or an AIRINC 809 connector, and the second hybrid connector may be an EN 4165 connector or an AIRINC 809 connector. For example, as shown in FIG. 5D, the male hybrid connector 550 and the female hybrid connector 560 are EN 4165 connectors.

FIG. 5E shows an example hybrid connecter set including a first hybrid connector and a second hybrid connector, implemented in a seat device of a transportation vehicle, according to an aspect of the present disclosure. In the example shown in FIG. 5E, a hybrid connector set 575 is implemented at a seat box 570 and includes a hybrid connector set 575 including a first hybrid connector 576 and a second hybrid connector 577. The seat box 570 may have similar features to the seat box 370 of FIG. 3A. In an example, the first hybrid connector 576 may be a male hybrid connector that is capable of coupling with another female hybrid connector and the second hybrid connector 577 may be a female hybrid connector capable of coupling with another male hybrid connector. For example, the first hybrid connector 576 may be the male hybrid connector 550 of FIG. 5D and the second hybrid connector 577 may be the female hybrid connector 560 of FIG. 5D. In an aspect, the seat box 570 may be similar to the seat box 370 of FIG. 3A. In an example, the first hybrid connector 576 may be used to receive power and data, while the second hybrid connector 577 may be used to send power and data to another device.

In some aspects, the first power connections in the first power interface component may be a first AC power connection for a first phase AC power, a second AC power connection for a second phase AC power, a third AC power connection for a third phase AC power, a first ground connection, a first neutral connection, and a first key line connection. Further, in some aspects, the second power connections in the first power interface component may be a fourth AC power connection for the first phase AC power, a fifth AC power connection for the second phase AC power, a sixth AC power connection for the third phase AC power, a second ground connection, a second neutral connection, and a second key line connection. In some aspects, the first key line connection may be the smallest in size among the first power connections, and the second key line connection may be the smallest in size among the second power connections.

In an example where the first hybrid connector and the second hybrid connector are the male hybrid connector 550 and the female hybrid connector 560 of FIG. 5D, respectively, the first power connections of the first hybrid connector may be the 6 pins of the power connections 554 of the male hybrid connector 550 that are three AC power connections for the first phase AC power, the second phase AC power, and the third phase AC power, a ground connection, a neutral connection, and a key line connection. As shown in FIG. 5D, the key line connection is the smallest in size among the 6 pins of the power connections 554. Further, in this example, the second power connections of the second hybrid connector may be the 6 recesses of the power connections 564 of the female hybrid connector 560 that are three AC power connections for the first phase AC power, the second phase AC power, and the third phase AC power, a ground connection, a neutral connection, and a key line connection. As shown in FIG. 5D, the key line connection is the smallest in size among the 6 pins of the power connections 564.

In an aspect, two adjacent connections of the first AC power connection, the second AC power connection, the third AC power connection, the first ground connection, and the first neutral connection may be spaced from each other by a same distance. In an aspect, a distance between the first key line connection and at least one of the first power connections that is adjacent to the first key line connection may be different from a distance between the first key line connection and another one of the first power connections that is adjacent to the first key line connection.

In an example where the first hybrid connector and the second hybrid connector are the male hybrid connector 550 and the female hybrid connector 560 of FIG. 5D, respectively, two adjacent connections of the five of the power connections 554 (other than the keyline pin) are spaced from each other by the same distance. Further, as shown in FIG. 5D, the distance between the key line connection and a power connection adjacent to the key line connection above the key line connection is different from a distance between the key line connection and a power connection adjacent to the key line connection at a side of the key line connection are different.

In an aspect, two adjacent connections of the fourth AC power connection, the fifth AC power connection, the sixth AC power connection, the second ground connection, and the second neutral connection may be spaced from each other by a same distance. In an aspect, a distance between the second key line connection and at least one of the second power connections that is adjacent to the second key line connection may be different from a distance between the second key line connection and another one of the second power connections that is adjacent to the second key line connection.

In an example where the first hybrid connector and the second hybrid connector are the male hybrid connector 550 and the female hybrid connector 560 of FIG. 5D, respectively, two adjacent connections of the five of the power connections 564 (other than the keyline pin) are spaced from each other by the same distance. Further, as shown in FIG. 5D, the distance between the key line connection and a power connection adjacent to the key line connection above the key line connection is different from a distance between the key line connection and a power connection adjacent to the key line connection at a side of the key line connection are different. This is also shown in the example of FIG. 5B.

According to an aspect of the disclosure, a hybrid cable unit for providing power and data to a seat box or another device in a transportation vehicle is provided. The hybrid cable unit includes a hybrid cable with electric wires and multiple optical fibers, where the hybrid cable has a first end and a second end. The hybrid cable unit further includes a first hybrid connector connected to the electric wires and the multiple optical fibers at the first end of the hybrid cable and configured to receive power and data. The hybrid cable unit also includes a second hybrid connector connected to the electric wires and the multiple optical fibers at the second end and configured to deliver the power and the data received via the first hybrid connector to a different seat box.

The first hybrid connector includes a first power interface component providing a first power interface via first power connections to receive the three phase electric power with three AC phases. The first hybrid connector further includes a first fiber optic interface component providing a first fiber optic interface via multiple first fiber optic connections to receive data communication. In the first hybrid connector, the first power connections included in the first power interface component are connected to the electric wires and are configured to receive the three-phase electric power for the seat box, while the multiple first fiber optic connections included in the fiber optic interface component are connected to the multiple optical fibers and are configured to receive the data communication via the multiple optical fibers. The first hybrid connector also includes a first housing configured to house the first power interface component and the first fiber optic interface component, where the first housing includes a single first hybrid interface providing the first power interface and the first fiber optic interface.

The second hybrid connector includes a second power interface component providing a second power interface via second power connections to send the three phase electric power with three AC phases to the different seat box. The second hybrid connector further includes a second fiber optic interface component providing a second fiber optic interface via multiple second fiber optic connections to send data communication to the different seat box. In the second hybrid connector, the second power connections included in the second power interface component are connected to the electric wires and are configured to send the three-phase electric power to the different seat box, while the multiple second fiber optic connections included in the fiber optic interface component are connected to the multiple optical fibers and are configured to send the data communication to the different seat box via multiple optical fibers. The second hybrid connector also includes a second housing configured to house the second power interface component and the second fiber optic interface component, where the second housing includes a single second hybrid interface providing the second power interface and the second fiber optic interface.

In some aspects, the first fiber optic interface may be an MPO connection interface or an MTP connection interface. In some aspects, the second fiber optic interface may be an MPO connection interface or an MTP connection interface. In some aspects, the first hybrid connector may be an EN4165 connector or an AIRINC 809 connector, and the second hybrid connector may be an EN 4165 connector or an AIRINC 809 connector.

In some aspects, the first power connections in the first power interface component may be a first AC power connection for a first phase AC power, a second AC power connection for a second phase AC power, a third AC power connection for a third phase AC power, a first ground connection, a first neutral connection, and a first key line connection. Further, in some aspects, the second power connections in the first power interface component may be a fourth AC power connection for the first phase AC power, a fifth AC power connection for the second phase AC power, a sixth AC power connection for the third phase AC power, a second ground connection, a second neutral connection, and a second key line connection. In some aspects, the first key line connection may be the smallest in size among the first power connections, and the second key line connection may be the smallest in size among the second power connections.

In an aspect, two adjacent connections of the first AC power connection, the second AC power connection, the third AC power connection, the first ground connection, and the first neutral connection may be spaced from each other by a same distance. In an aspect, a distance between the first key line connection and at least one of the first power connections that is adjacent to the first key line connection may be different from a distance between the first key line connection and another one of the first power connections that is adjacent to the first key line connection. In an aspect, two adjacent connections of the fourth AC power connection, the fifth AC power connection, the sixth AC power connection, the second ground connection, and the second neutral connection may be spaced from each other by a same distance. In an aspect, a distance between the second key line connection and at least one of the second power connections that is adjacent to the second key line connection may be different from a distance between the second key line connection and another one of the second power connections that is adjacent to the second key line connection.

FIG. 5F shows an example hybrid cable unit for providing power and data to a seat box or another device in a transportation vehicle, where the hybrid cable unit includes a first hybrid connector at one end of a hybrid cable and a second hybrid connector at the other end of the hybrid cable, according to an aspect of the present disclosure. In the example shown in FIG. 5F, a hybrid cable unit 590 includes a hybrid cable 591 a first hybrid connector 592 and a second hybrid connector 593. The hybrid cable unit 590 may include electric wires for delivering the three-phase electric power and multiple optical fibers for communicating data. In an example, the first hybrid connector 592 may be a male hybrid connector that is capable of coupling with another female hybrid connector and the second hybrid connector 593 may be a female hybrid connector capable of coupling with another male hybrid connector. For example, the first hybrid connector 592 may be the male hybrid connector 550 of FIG. 5D and the second hybrid connector 593 may be the female hybrid connector 560 of FIG. 5D. In an example, the first hybrid connector 592 may be used to receive power and data from one device, while the second hybrid connector 593 may be used to provide power and data to another device.

The first power interface component, the first fiber optic interface component, and the first housing of the first hybrid connector and the second power interface component, the second fiber optic interface component, and the second housing of the second hybrid connector in the hybrid cable unit may include similar features of those of the first hybrid connector and the second hybrid connector of the hybrid connector set described above. Therefore, further descriptions of the first hybrid connector and the second hybrid connector in the hybrid cable unit in reference to FIG. 5D are omitted.

FIG. 5G shows an example diagram illustrating a seat box connecting to a hybrid cable unit via a hybrid connector set in a transportation vehicle, according to an aspect of the present disclosure. A seat box 570 in FIG. 5G for a transportation vehicle may have similar features to the seat box 370 of FIG. 3A. Further, the server 354 and the power generator 390 in FIG. 5G may be the server 354 shown in FIG. 3A and FIG. 3B and the power generator 390 may be the power generator shown in FIG. 3B. The server 354 communicates digital data via multiple optical fibers connected to the server 354 and the power generator 390 provides the three-phase electric power with the three AC phases via electric wires connected to the power generator 390. The multiple optical fibers connected to the server 354 and the electric wires connected to the power generator 390 may be included in a source hybrid cable 581 and may be connected to a hybrid connector 578 at the end of the source hybrid cable 581. In the example of FIG. 5G, the hybrid connector 392 In FIG. 5G, the seat box 570 includes the hybrid connector set 575 including the first hybrid connector 576 being a male connector and the second hybrid connector 577 being a female connector. In an example, the first hybrid connector 576 and the second hybrid connector 577 may be included in the hybrid connector set 575.

The hybrid connector 582 connected to the source hybrid cable 581 may be coupled to the first hybrid connector 576 at the seat box 570 to deliver the three-phase electric power from the server 354 and to communicate digital data with the server 354. Further, the second hybrid connector 577 at the seat box 570 may be coupled to the first hybrid connector 592 of the hybrid cable unit 590, such that the three-phase electric power and the digital data may be communicated to the second hybrid connector 593 of the hybrid cable unit 590 via the hybrid cable 591.

FIG. 5H shows an example diagram illustrating multiple seat boxes connected to one another via hybrid cable units and via hybrid connector sets in a transportation vehicle, according to an aspect of the present disclosure. Each of the seat boxes 570A, 570B, and 570C in FIG. 5H may have the same or similar features as the seat box 370 shown in FIG. 3A. Further, the server 354 and the power generator 390 in FIG. 5G may be the server 354 shown in FIG. 3A and FIG. 3B and the power generator 390 may be the power generator shown in FIG. 3B. The seat box 570A has a hybrid connector set 575A including a first hybrid connector 576A being a male connector and a second hybrid connector 577A being a female connector. The seat box 570B has a hybrid connector set 575B including a first hybrid connector 576B being a male connector and a second hybrid connector 577B being a female connector. The seat box 570C has a hybrid connector set 575C including a first hybrid connector 576C being a male connector and a second hybrid connector 577C being a female connector.

A hybrid cable unit 590A is used to connect the seat box 570A and the seat box 570B to deliver electric power and communicate data. The hybrid cable unit 590A has a hybrid cable 591A and a first hybrid connector 592A being a male connector at one end of the hybrid cable 591A and a second hybrid connector 593B being a female connector at the other end of the hybrid cable 591A. A hybrid cable unit 590B is used to connect the seat box 570B and the seat box 570C to deliver electric power and communicate data. The hybrid cable unit 590B has a hybrid cable 591B and a first hybrid connector 592B being a male connector at one end of the hybrid cable 591B and a second hybrid connector 593B being a female connector at the other end of the hybrid cable 591B. Each of the hybrid cable units 590A and 590B may have similar features to the hybrid cable unit 590 of FIG. 5F and FIG. 5G. In an example, the male connectors in FIG. 5H may be similar to the male hybrid connector 550 of FIG. 5D, and the female connectors in FIG. 5H may be similar to the female hybrid connector 560 of FIG. 5D.

In the example shown in FIG. 5H, the hybrid connector 582 connected to the source hybrid cable 581 is coupled to the first hybrid connector 576A at the seat box 570A to deliver the three-phase electric power from the server 354 and to communicate digital data with the server 354. Further, the second hybrid connector 577A at the seat box 570A is coupled to the first hybrid connector 592A of the hybrid cable unit 590A and the second hybrid connector 593A of the hybrid cable unit 590A is coupled to the first hybrid connector 576B at the seat box 570B, such that the electric power and the digital data may be communicated from the seat box 570A to the seat box 570B via a hybrid cable 591A of the hybrid cable unit 590A. In addition, the second hybrid connector 577B at the seat box 570B is coupled to the first hybrid connector 592B of the hybrid cable unit 590B and the second hybrid connector 593B of the hybrid cable unit 590B is coupled to the first hybrid connector 576C at the seat box 570C, such that the electric power and the digital data may be communicated from the seat box 570B to the seat box 570C via a hybrid cable 591B of the hybrid cable unit 590B.

In a transportation vehicle such as an airplane, the generator provides three phases of AC power and a phase rotation is configured. For example, with the phase rotation, a first seat may be powered with the Phase A power, a second seat may be powered with the Phase B power, and a third seat may be powered by the Phase C power. By using the three phase power with the phase rotation, load balancing can be achieved for the load on the generator such that one phase is not pulling a more load than another phase.

In FIG. 5H, for example, the seat box 570A receives the three-phase electric power and utilizes the Phase A power, and the electric power with the remaining phases may be sent to the seat box 570B. Then, the seat box 570B utilizes the Phase B power and then may send the electric power with Phase C to the seat box 570C, such that the seat box 570C may utilize the Phase C power. By spreading the three phases to different seat boxes, the load is spread out to the three phases, thus providing load balancing without having all load is put on one phase

Thus, a hybrid connector to provide a fiber-optic communication and a power supply connection for a seat-related device, such as a seat box, in a transportation vehicle as well as a hybrid connector set and a hybrid cable unit that utilize the hybrid connector features have been described. Note that references throughout this specification to “one aspect” (or “embodiment”) or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the disclosure, as will be recognized by those of ordinary skill in the art.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

What is claimed is:

1. A hybrid connector for a seat box of a transportation vehicle, comprising:
a power interface component comprising a plurality of power connections configured to deliver three-phase electric power with three alternating current (AC) phases for the seat box, the power interface component configured to provide a power interface via the plurality of power connections to receive or send the three-phase electric power;
a fiber optic interface component comprising a plurality of fiber optic connections configured for data communication via a plurality of optical fibers, the fiber optic interface component configured to provide a fiber optic interface via the plurality of fiber optic connections to receive or send data; and
a housing configured to house the power interface component and the fiber optic interface component and comprising a single hybrid interface providing the power interface of the power interface component and the fiber optic interface of the fiber optic interface component.

2. The hybrid connector of claim 1, wherein the hybrid interface is configured to couple with an opposing hybrid interface of an opposing hybrid connector with an opposing power interface for the three-phase electric power and an opposing fiber optic interface for the data communication.

3. The hybrid connector of claim 1, wherein the plurality of power connections in the power interface component are a first AC power connection for a first phase AC power, a second AC power connection for a second phase AC power, a third AC power connection for a third phase AC power, a ground connection, a neutral connection, and a key line connection.

4. The hybrid connector of claim 3, wherein the key line connection is smallest in size among the plurality of power connections.

5. The hybrid connector of claim 3, wherein two adjacent connections of the first AC power connection, the second AC power connection, the third AC power connection, the ground connection, and the neutral connection are spaced from each other by a same distance, and
wherein a distance between the key line connection and at least one of the plurality of power connections that is adjacent to the key line connection is different from a distance between the key line connection and another one of the plurality of power connections that is adjacent to the key line connection.

6. The hybrid connector of claim 1, wherein the plurality of fiber optic connections include more than two fiber optic connections arranged linearly.

7. The hybrid connector of claim 1, wherein the hybrid interface is a non-concentric interface with a first half of an area of the hybrid interface being configured for the power interface and a second half of the area of the hybrid interface being configured for the fiber optic interface.

8. The hybrid connector of claim 1, wherein the fiber optic interface is a multi-fiber push on (MPO) connection interface or a Multi-Fiber Termination Push-On (MTP) interface.

9. The hybrid connector of claim 1, wherein the hybrid connector is an EN4165 connector or an AIRINC 809 connector.

10. A hybrid connector set for a seat box in a transportation vehicle, comprising:
a first hybrid connector configured to receive power and data, the first hybrid connector comprising:
a first power interface component comprising a plurality of first power connections configured to receive three-phase electric power with three alternating current (AC) phases for the seat box, the first power interface component configured to provide a first power interface via the plurality of first power connections to receive the three phase electric power,
a first fiber optic interface component comprising a plurality of first fiber optic connections configured to receive data communication via a plurality of first optical fibers, the first fiber optic interface component configured to provide a first fiber optic interface via the plurality of first fiber optic connections to receive the data communication, and
a first housing configured to house the first power interface component and the first fiber optic interface component and comprising a single first hybrid interface providing the first power interface of the first power interface component and the first fiber optic interface of the first fiber optic interface component; and
a second hybrid connector configured to relay the power and the data received via the first hybrid connector to an additional seat box separate from the seat box, the second hybrid connector comprising:
a second power interface component comprising a plurality of second power connections configured to send the three-phase electric power with the three AC phases to the additional seat box, the second power interface component configured to provide a second power interface via the plurality of second power connections to send the three-phase electric power,
a second fiber optic interface component comprising a plurality of second fiber optic connections configured to send data communication to the additional seat box via a plurality of second optical fibers, the second fiber optic interface component configured to provide a second fiber optic interface via the plurality of second fiber optic connections to send the data communication, and
a second housing configured to house the second power interface component and the second fiber optic interface component and comprising a single second hybrid interface providing the second power interface of the second power interface component and the second fiber optic interface of the second fiber optic interface component.

11. The hybrid connector set of claim 10, wherein the plurality of first power connections in the first power interface component are a first AC power connection for a first phase AC power, a second AC power connection for a second phase AC power, a third AC power connection for a third phase AC power, a first ground connection, a first neutral connection, and a first key line connection, and
wherein the plurality of second power connections in the first power interface component are a fourth AC power connection for the first phase AC power, a fifth AC power connection for the second phase AC power, a sixth AC power connection for the third phase AC power, a second ground connection, a second neutral connection, and a second key line connection.

12. The hybrid connector set of claim 11, wherein the first key line connection is smallest in size among the plurality of first power connections, and the second key line connection is smallest in size among the plurality of second power connections.

13. The hybrid connector set of claim 11, wherein two adjacent connections of the first AC power connection, the second AC power connection, the third AC power connection, the first ground connection, and the first neutral connection are spaced from each other by a same distance,
wherein a distance between the first key line connection and at least one of the plurality of first power connections that is adjacent to the first key line connection is different from a distance between the first key line connection and another one of the plurality of first power connections that is adjacent to the first key line connection,
wherein two adjacent connections of the fourth AC power connection, the fifth AC power connection, the sixth AC power connection, the second ground connection, and the second neutral connection are spaced from each other by a same distance, and
wherein a distance between the second key line connection and at least one of the plurality of second power connections that is adjacent to the second key line connection is different from a distance between the second key line connection and another one of the plurality of second power connections that is adjacent to the second key line connection.

14. The hybrid connector set of claim 10, wherein the first fiber optic interface is a multi-fiber push on (MPO) connection interface or a Multi-Fiber Termination Push-On (MTP) interface, and the second fiber optic interface an MPO connection interface or an MTP interface.

15. The hybrid connector set of claim 10, wherein the first hybrid connector is an EN4165 connector or an AIRINC 809 connector, and the second hybrid connector is an EN 4165 connector or an AIRINC 809 connector.

16. The hybrid connector set of claim 10, wherein the first hybrid connector is a male connector and the second hybrid connector is a female connector.

17. A hybrid cable unit for providing power and data to a seat box of a transportation vehicle, the hybrid cable unit comprising:
a hybrid cable including a plurality of electric wires and a plurality of optical fibers, the hybrid cable having a first end and a second end;
a first hybrid connector connected to the plurality of electric wires and the plurality of optical fibers at the first end and configured to receive power and data, the first hybrid connector comprising:
a first power interface component comprising a plurality of first power connections connected to the plurality of electric wires and configured to receive three-phase electric power with three alternating current (AC) phases for the seat box, the first power interface component configured to provide a first power interface via the plurality of first power connections to receive the three phase electric power,
a first fiber optic interface component comprising a plurality of first fiber optic connections connected to the plurality of optical fibers and configured to receive data communication via the plurality of optical fibers, the first fiber optic interface component configured to provide a first fiber optic interface via the plurality of first fiber optic connections to receive the data communication, and
a first housing configured to house the first power interface component and the first fiber optic interface component and comprising a single first hybrid interface providing the first power interface of the first power interface component and the first fiber optic interface of the first fiber optic interface component; and
a second hybrid connector connected to the plurality of electric wires and the plurality of optical fibers at the second end and configured to deliver the power and the data received via the first hybrid connector to an additional seat box separate from the seat box, the second hybrid connector comprising:
a second power interface component comprising a plurality of second power connections connected to the plurality of electric wires and configured to send the three-phase electric power with the three AC phases to the additional seat box, the second power interface component configured to provide a second power interface via the plurality of second power connections to send the three-phase electric power,
a second fiber optic interface component comprising a plurality of second fiber optic connections connected to the plurality of optical fibers and configured to send data communication to the additional seat box via the plurality of optical fibers, the second fiber optic interface component configured to provide a second fiber optic interface via the plurality of second fiber optic connections to send the data communication, and
a second housing configured to house the second power interface component and the second fiber optic interface component and comprising a single second hybrid interface providing the second power interface of the second power interface component and the second fiber optic interface of the second fiber optic interface component.

18. The hybrid cable unit of claim 17, wherein the plurality of first power connections in the first power interface component are a first AC power connection for a first phase AC power, a second AC power connection for a second phase AC power, a third AC power connection for a third phase AC power, a first ground connection, a first neutral connection, and a first key line connection, and
wherein the plurality of second power connections in the first power interface component are a fourth AC power connection for the first phase AC power, a fifth AC power connection for the second phase AC power, a sixth AC power connection for the third phase AC power, a second ground connection, a second neutral connection, and a second key line connection.

19. The hybrid cable unit of claim 18, wherein the first key line connection is smallest in size among the plurality of first power connections, and the second key line connection is smallest in size among the plurality of second power connections.

20. The hybrid cable unit of claim 17, wherein the first hybrid connector is a male connector and the second hybrid connector is a female connector.
